(19) United States
(12) Patent Application Publication
(10) Pub. No.: US 2026/0024141 A1
(43) Pub. Date: Jan. 22, 2026

(54) INFORMATION PROCESSING APPARATUS, SUPPORT METHOD, AND NON-TRANSITORY COMPUTER-READABLE MEDIUM

(71) Applicant: NEC Corporation, Tokyo (JP)

(72) Inventors: Daichi IWATA, Tokyo (JP); Chika Asahina, Tokyo (JP); Hirofumi Sato, Tokyo (JP); Mitsuhiro Watanabe, Tokyo (JP)

(73) Assignee: NEC Corporation, Tokyo (JP)

(21) Appl. No.: 19/256,511

(22) Filed: Jul. 1, 2025

(30) Foreign Application Priority Data
Jul. 18, 2024 (JP) 2024-115038

(51) Int. Cl. G06Q 40/06; G06F 16/3329; G06F 16/353

(52) U.S. Cl. CPC G06Q 40/0631; G06F 16/33295; G06F 16/353; G06Q 40/064

(57) ABSTRACT

An object of the present disclosure is to improve a technique of presenting a portfolio of asset management according to a subject. An information processing apparatus includes a question selection unit that selects a question to be presented next from among unpresented questions included in a question group based on an answer to a question selected from the question group for determining a portfolio of asset management and presented to a subject, and a presentation control unit that presents, to the subject, a portfolio according to an answer of the subject to each of the selected and presented questions. According to this information processing apparatus, it is possible to support the decision making of the subject for asset management.

### INCORPORATION BY REFERENCE

This application is based upon and claims the benefit of priority from Japanese patent application No. 2024-115038, filed on Jul. 18, 2024, the disclosure of which is incorporated herein in its entirety by reference.

### TECHNICAL FIELD

The present disclosure relates to an information processing apparatus, a support method, and a support program.

### BACKGROUND ART

In asset management, it is preferable to first determine a portfolio and then consider a specific investment destination such as selection of a financial product according to the portfolio. However, since the optimal portfolio varies depending on the life stage of the manager, the way of thinking of investment, the managed fund, and the like, it is not easy for many people to create a portfolio.

Consultation with experts such as banks or financial planners is one measure for creating an optimal portfolio. As a more easy measure, it is conceivable to use a service that automatically proposes a portfolio according to the content of answers based on the answers to a plurality of questions regarding asset management prepared in advance. As related art related to such a service, for example, there is a recommendation service system disclosed in Patent Literature 1.
Patent Literature 1: Japanese Unexamined Patent Application Publication No. 2004-341784

### SUMMARY

In a case where questions regarding asset management prepared in advance are presented to a service subject, if there are few questions to be presented, it is difficult to determine a portfolio sufficiently adapted to the subject. Conversely, if there are too many questions to be presented, the possibility of determining a portfolio suitable for the subject can be increased, but the burden on the subject who answers the question increases. Since the matters to be checked are different depending on subjects in the first place, it is difficult to avoid occurrence of a mismatch in a case where the same question is presented to all the subjects. For example, if a question regarding a retirement allowance is made to a subject in his/her twenties or a question regarding long-term asset management is made to a subject in his/her eighties, a useful answer is unlikely to be obtained in determining a portfolio suitable for those subjects.

The present disclosure has been made in view of such a problem, and an example object thereof is to improve a technique of presenting a portfolio of asset management according to a subject based on an answer of the subject to a question.

An information processing apparatus according to an example aspect of the present disclosure includes a question selection unit that selects a question to be presented to a subject next from among unpresented questions among questions included in a question group based on an answer of the subject to a question selected from the question group for determining a portfolio of asset management and presented to the subject; and a presentation control unit that presents, to the subject, a portfolio according to an answer of the subject to each of the selected and presented questions.

A support method according to an example aspect of the present disclosure includes a question selection process in which at least one processor selects a question to be presented to a subject next from among unpresented questions among questions included in a question group based on an answer of the subject to a question selected from the question group for determining a portfolio of asset management and presented to the subject; and a presentation control process in which the at least one processor presents, to the subject, a portfolio according to an answer of the subject to each of the selected and presented questions.

A support program according to an example aspect of the present disclosure causes a computer to function as a question selection unit that selects a question to be presented to a subject next from among unpresented questions among questions included in a question group based on an answer of the subject to a question selected from the question group for determining a portfolio of asset management and presented to the subject; and a presentation control unit that presents, to the subject, a portfolio according to an answer of the subject to each of the selected and presented questions.

According to an example aspect of the present disclosure, it is possible to achieve an exemplary effect that it is possible to improve a technique of presenting a portfolio of asset management according to a subject based on an answer of the subject to a question.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of an information processing apparatus according to the present disclosure;

FIG. 2 is a flowchart illustrating a flow of a support method according to the present disclosure;

FIG. 3 is a block diagram illustrating a configuration of another information processing apparatus according to the present disclosure;

FIG. 4 is a diagram illustrating an example of a display screen for presenting a portfolio;

FIG. 5 is a flowchart illustrating a flow of a process executed by the information processing apparatus illustrated in FIG. 3;

FIG. 6 is a flowchart illustrating a series of processes related to prediction of a question item;

FIG. 7 is a flowchart illustrating a series of processes of investment destination determination support; and

FIG. 8 is a block diagram illustrating a configuration of a computer that functions as the information processing apparatus according to the present disclosure.

### EXAMPLE EMBODIMENT

Hereinafter, example embodiments will be exemplified. However, the present disclosure is not limited to exemplary embodiments described below, and various alterations can be made within the scope described in the claims. For example, example embodiments obtained by appropriately combining techniques (some or all of things or methods) employed in the following exemplary embodiments can also be included in the scope of the present disclosure. Example embodiments obtained by appropriately omitting some of the techniques employed in the following exemplary embodiments can also be included in the scope of the present disclosure. Effects mentioned in the following exemplary embodiments are examples of effects expected in the exemplary embodiments, and do not define the extension of the present disclosure. That is, example embodiments that do not achieve the effects mentioned in the following exemplary embodiments can also be included in the scope of the present disclosure.

### First Exemplary Embodiment

A first exemplary embodiment, which is an example of an example embodiment, will be described in detail with reference to the drawings. The present exemplary embodiment is a basic form of each exemplary embodiment described below. An application scope of each technique employed in the present exemplary embodiment is not limited to the present exemplary embodiment. That is, each technique employed in the present exemplary embodiment can also be employed in the other exemplary embodiments included in the present disclosure within the scope in which no particular technical problem occurs. Each technique illustrated in the drawings referred to for describing the present exemplary embodiment can also be employed in the other exemplary embodiments included in the present disclosure within the scope in which no particular technical problem occurs.

### (Configuration of Information Processing Apparatus 1)

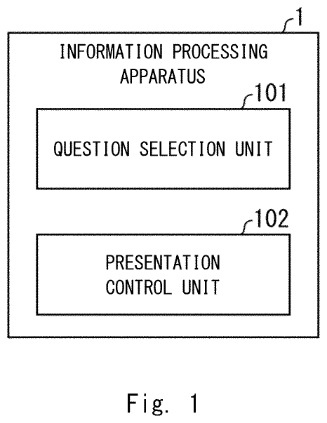

A configuration of an information processing apparatus 1 will be described with reference to FIG. 1. FIG. 1 is a block diagram illustrating a configuration of the information processing apparatus 1. As illustrated in FIG. 1, the information processing apparatus 1 includes a question selection unit 101 and a presentation control unit 102.

The question selection unit 101 selects a question to be presented to a subject next from among questions that have not been presented to the subject among questions included in a question group based on an answer of the subject to a question selected from the question group for determining the portfolio of asset management and presented to the subject.

The “subject” is a person who is a target for which a portfolio of asset management is determined.

Here, the “portfolio of asset management” indicates asset allocation in asset management. For example, it is assumed that assets of 10 million yen are equally invested and managed in each of domestic stocks, domestic bonds, foreign stocks, and foreign bonds. The portfolio in this case would allocate 25% of each asset to domestic stocks, domestic bonds, foreign stocks, and foreign bonds. Any allocation destination may be set, and for example, financial assets such as deposits and insurance, and real assets such as real estate and precious metals may be included in the allocation destinations.

The presentation control unit 102 presents, to the subject, a portfolio according to an answer of the subject to each of the questions selected by the question selection unit 101 and presented to the subject. Methods and aspects of presentation are optional. For example, the presentation control unit 102 may present the portfolio by causing any output device to output the portfolio. An output aspect may be, for example, display output, speech output, or print output. The output device may be included in the information processing apparatus 1 or may be a device outside the information processing apparatus 1. In a case where the portfolio is presented by displaying or printing out the portfolio, the presentation control unit 102 may present the portfolio by using an image such as a circular graph.

As described above, the information processing apparatus 1 includes: the question selection unit 101 that selects a question to be presented to the subject next from among unpresented questions among questions included in the question group based on an answer of the subject to a question selected from the question group for determining a portfolio of asset management and presented to the subject; and the presentation control unit 102 that presents a portfolio corresponding to the answer of the subject to each of the selected and presented questions to the subject.

According to the above configuration, since a question to be presented next is selected based on an answer of a subject to the previous question, it is possible to collect information necessary for determining a portfolio suitable for the subject through the minimum number of questions according to the subject and present the portfolio suitable for the subject. As described above, according to the information processing apparatus 1, it is possible to achieve an effect of improving the technique of presenting a portfolio of asset management according to a subject based on an answer of the subject to a question. According to the information processing apparatus 1, it is possible to support the decision making of a subject in asset management by presenting a portfolio suitable for the subject.

### (Support Program)

The above-described functions of the information processing apparatus 1 can also be achieved by a program. A support program according to the present exemplary embodiment is a program used for supporting asset management, and causes a computer to function as: question selection means for selecting, based on an answer of a subject to a question selected from a question group for determining a portfolio of asset management and presented to the subject, a question to be presented next to the subject from among unpresented questions among questions included in the question group; and presentation control means for presenting, to the subject, a portfolio according to an answer of the subject to each of the selected and presented questions. According to this support program, it is possible to achieve an effect of improving a technique of presenting a portfolio of asset management according to a subject based on an answer of the subject to a question.

### (Flow of Support Method)

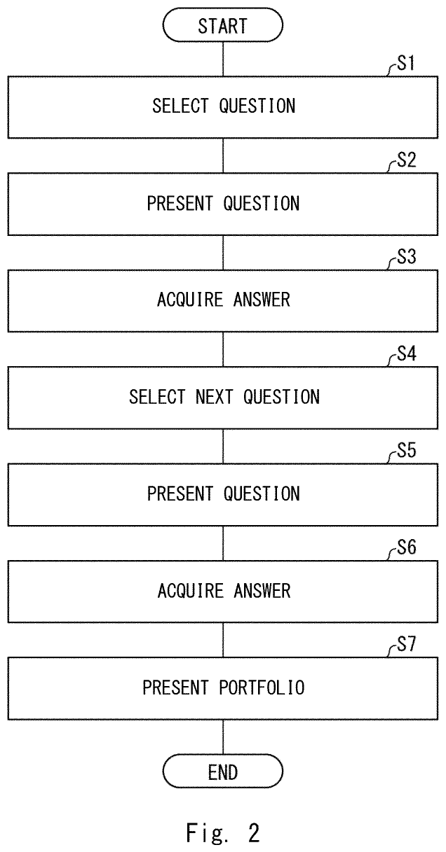

A flow of a support method will be described with reference to FIG. 2. FIG. 2 is a flowchart illustrating a flow of the support method. An executing entity of each step in this support method may be a processor included in the information processing apparatus 1, may be a processor included in another apparatus, or may be a processor provided in an apparatus in which executing entities of each step are different.

In S1, at least one processor selects a question from a question group for determining a portfolio of asset management. One question or a plurality of questions may be selected in S1.

In S2, at least one processor presents the question selected in S1 to the subject. In S3, at least one processor acquires an answer of the subject to the question presented in S2. In a case where a plurality of questions are selected in S1, each of the plurality of selected questions is presented, and an answer to each presented question is acquired in S2 and S3. A plurality of questions may be presented at a time, or may be sequentially presented at a plurality of times.

In S4 (question selection process), at least one processor selects a question to be presented to the subject next from among questions that have not been presented to the subject among the questions included in the question group based on the answer acquired in S3. Here, the answer acquired in S3 is an answer of the subject to the question generated in S1 and presented in S2. Similarly to S1, one question or a plurality of questions may be selected in S4.

In S5, at least one processor presents the question selected in S4 to the subject. In S6, at least one processor acquires an answer of the subject to the question presented in S5. The processes in S5 and S6 in a case where a plurality of questions are selected in S4 are similar to the processes in S2 and S3 in a case where a plurality of questions are selected in S1.

In S7 (presentation process), at least one processor presents the answers of the subject to each of the questions selected and presented through each of the processes in S1, S2, S4, and S5, that is, a portfolio according to each of the answers acquired in S3 and S6 to the subject.

As described above, the support method according to the present exemplary embodiment is a support method for supporting asset management, the support method including: a question selection process in which at least one processor selects, based on an answer of a subject to a question selected from a question group for determining a portfolio of asset management and presented to the subject, a question to be presented next to the subject from among unpresented questions among questions included in the question group; and a presentation control process in which the at least one processor presents, to the subject, a portfolio according to an answer of the subject to each of the selected and presented questions. Therefore, according to the support method of the present example embodiment, it is possible to achieve an effect of improving the technique of presenting a portfolio of asset management according to a subject based on an answer of the subject to a question.

### Second Exemplary Embodiment

A second exemplary embodiment, which is an example of an example embodiment, will be described in detail with reference to the drawings. Constituents having the same functions as the constituents described in the above-described exemplary embodiment are denoted by the same reference sign, and the description thereof will be omitted as appropriate. An application scope of each technique employed in the present exemplary embodiment is not limited to the present exemplary embodiment. That is, each technique employed in the present exemplary embodiment can also be employed in the other exemplary embodiments included in the present disclosure within the scope in which no particular technical problem occurs. Each technique illustrated in each of the drawings referred to for describing the present exemplary embodiment can be employed in the other exemplary embodiments included in the present disclosure within the scope in which no particular technical problem occurs.

### (Configuration of Information Processing Apparatus 1A)

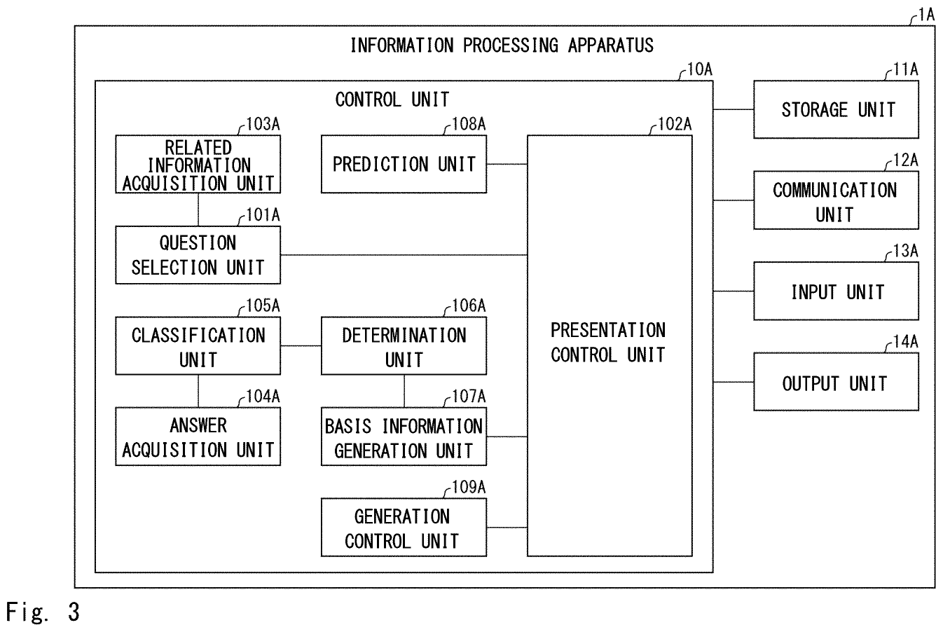

Next, a configuration of an information processing apparatus 1A will be described with reference to FIG. 3. FIG. 3 is a block diagram illustrating the configuration of the information processing apparatus 1A. The information processing apparatus 1A is an apparatus having a function of supporting asset management. The information processing apparatus 1A may be an apparatus of which the main function is to support asset management, or may be a general-purpose apparatus having other functions. The information processing apparatus 1A may be a stationary apparatus or a portable apparatus.

As illustrated in FIG. 3, the information processing apparatus 1A includes a control unit 10A that integrally controls units of the information processing apparatus 1A, and a storage unit 11A that stores various types of data to be used by the information processing apparatus 1A. The information processing apparatus 1A includes a communication unit 12A for the information processing apparatus 1A to communicate with another apparatus, an input unit 13A that receives an input to the information processing apparatus 1A, and an output unit 14A for the information processing apparatus 1A to output data. The control unit 10A includes a question selection unit 101A, a presentation control unit 102A, a related information acquisition unit 103A, an answer acquisition unit 104A, a classification unit 105A, a determination unit 106A, a basis information generation unit 107A, a prediction unit 108A, and a generation control unit 109A. Details of the prediction unit 108A and the generation control unit 109A will be described later.

Similarly to the question selection unit 101 described in the first exemplary embodiment, the question selection unit 101A selects a question to be presented to a subject next from among questions that have not been presented to the subject among questions included in a question group based on an answer of the subject to a question selected from the question group for determining a portfolio of asset management and presented to the subject.

The presentation control unit 102A presents various types of information to the subject. For example, similarly to the presentation control unit 102 described in the first exemplary embodiment, the presentation control unit 102A presents, to the subject, a portfolio according to an answer of the subject to each question selected by the question selection unit 101A and presented to the subject. The presentation control unit 102A also presents, for example, a question selected by the question selection unit 101A or basis information indicating a basis for recommending a portfolio. Any presentation methods and aspects may be employed similarly to those of the presentation control unit 102 of the first exemplary embodiment.

As described above, the information processing apparatus 1A includes the question selection unit 101A that selects a question to be presented to a subject next from among unpresented questions among questions included in a question group based on an answer of the subject to a question selected from a question group for determining the portfolio of asset management and presented to the subject, and the presentation control unit 102A that presents a portfolio according to an answer of the subject to each of the selected and presented questions to the subject. Therefore, similarly to the information processing apparatus 1 according to the first exemplary embodiment, it is possible to achieve and effect of improving the technique of presenting a portfolio of asset management according to a subject based on an answer of the subject to a question.

The related information acquisition unit 103A acquires related information that is information used for the question selection unit 101A to select a question. The related information may be any information that can be used to select a question. For example, the related information acquisition unit 103A may acquire related information indicating an attribute of a subject who is a target for which a portfolio is to be determined. Examples of the attribute of the subject include personal characteristics (age, sex, occupation, assets held, past asset management history, etc.) registered in advance by the subject.

The answer acquisition unit 104A acquires an answer of the subject to the question selected by the question selection unit 101A and presented by the presentation control unit 102A. The answer of the subject may be input by text or by speech. In a case where the answer of the subject is input by speech, the answer acquisition unit 104A converts input speech into text by a speech recognition device (not illustrated), and acquires the text obtained through the conversion as an answer of the subject. The answer of the subject may be input via the input unit 13A or may be input via the communication unit 12A. The above speech recognition device may be included in the information processing apparatus 1A, or a speech recognition device outside the information processing apparatus 1A may be used.

The classification unit 105A classifies the subject based on answers of the subject to a plurality of questions selected by the question selection unit 101A and presented by the presentation control unit 102A. In a case where the classification unit 105A classifies the subject, the question selection unit 101A selects a question according to the classification of the subject as a question to be presented next after the plurality of questions. As a result, in addition to the effect achieved by the information processing apparatus 1, it is possible to achieve an effect of selecting and presenting an appropriate question according to the classification of the subject.

A classification method applied by the classification unit 105A is not particularly limited. For example, the classification unit 105A may evaluate the subject on a plurality of predetermined evaluation axes including at least one of knowledge of investment, experience of investment, confidence in investment, calm, and behavioral propensities, and classify the subject based on a result of the evaluation. Each of the above evaluation axes relates to an important factor in determining a portfolio for the subject. Therefore, according to the above configuration, in addition to the effect achieved by the information processing apparatus 1, it is possible to achieve an effect of selecting and presenting an appropriate question based on an evaluation result for an important factor in determining a portfolio for the subject. The “behavioral propensities” are tendencies of properties in behavior. For example, being able to handle an unexpected situation calmly is an example of the behavioral propensities.

An evaluation method in each evaluation axis is also optional. For example, in a case where a question for selecting an answer from a plurality of options is presented to the subject, an evaluation value on the evaluation axis may be assigned to each answer option for a related question. As a result, the classification unit 105A can add up the evaluation values assigned to the respective options selected by the subject for the plurality of presented questions for each evaluation axis, and obtain evaluation results for the subject on the respective evaluation axes. The classification unit 105A can plot the evaluation results for the subject in a feature space represented by a plurality of evaluation axes and classify the subject according to which of a plurality of preset areas the plot is included.

For example, the classification unit 105A may classify the subject by using a language model. In this case, the classification unit 105A may input, to the language model, a prompt for giving an instruction to classify the subject based on the answer together with the answer of the subject. As a result, information indicating the classification of the subject is output from the language model. In this case, by using a prompt that includes each category that is a candidate for the classification destination and gives an instruction to select a category suitable for the subject from the categories, information indicating which category the subject belongs to can be output.

The language model is a model obtained through machine learning of the arrangement of constituents (words and the like) in a sentence or the arrangement of a sentence and a sentence in a writing. For example, a generative pre-trained transformer (GPT) that outputs a sentence including an input character string by predicting a character string having a high probability following the input character string may be used as the language model used for classification of a subject. For example, a text-to-text transfer transformer (T5), bidirectional encoder representations from transformers (BERT), a robustly optimized BERT approach (RoBERTa), or efficient learning an encoder that classifies token replacements accurately (ELECTRA), or the like may be used for the classification of a subject.

For example, the classification unit 105A may classify the subject based on an evaluation result obtained by relatively evaluating the subject with another person. As a result, in addition to the effect achieved by the information processing apparatus 1, it is possible to achieve an effect of proposing various portfolios in a balanced manner to a group including persons to be subjected to relative evaluation. For example, in a case where a plurality of evaluation subjects are each subjected to absolute evaluation, there is a possibility that a bias occurs in the classification of the evaluation subjects, and portfolios presented to the evaluation subjects are similar. In this regard, in a case where classification is performed based on the evaluation results obtained through the relative evaluation, classification results are less likely to be biased, and thus it is possible to propose various portfolios in a well-balanced manner.

The “another person” only needs to be a person having some association with the subject, and may be, for example, another user of the asset management support service provided by the information processing apparatus 1A. A method of relative evaluation is also optional. For example, as described above, for a related question, an evaluation value on each evaluation axis may be assigned for each answer option. In this case, the classification unit 105A may calculate a sum of the evaluation values on the respective evaluation axes for each subject of the relative evaluation, and calculate a relative evaluation value of each subject by using the calculated sum. For example, the classification unit 105A may classify each subject by using a deviation value of the calculated sum as a relative evaluation value of each subject.

The determination unit 106A determines a portfolio to be presented to the subject based on an answer of the subject to each of the presented questions. A method of determining a portfolio is not particularly limited. For example, a plurality of patterns of portfolios may be prepared in advance, and application conditions may be provided for each portfolio. In this case, the determination unit 106A may determine which portfolio satisfies the application conditions for the portfolio for the answers of the subject, and determine a portfolio determined to satisfy the application conditions as the portfolio to be presented to the subject. The application conditions, in other words, rules for determining the portfolio according to the answer of the subject may be set as appropriate according to a rule base or the like.

For example, the determination unit 106A may determine a portfolio by using a language model. In this case, the determination unit 106A may input, to the language model, an answer of the subject, explanation of each candidate portfolio to be presented to the subject, and a prompt for giving an instruction to output a portfolio associated with the answer. As a result, information indicating the portfolio to be presented to the subject is output from the language model. In addition to the answer of the subject, other information serving as a reference for determining an optimal portfolio, such as the classification determined by the classification unit 105A or attribute information of the subject, may be input to the language model. In a case of using a prompt that includes a plurality of portfolios serving as candidates to be presented and gives an instruction to select a portfolio that is suitable for the subject from among the portfolios, information indicating a portfolio to be presented to the subject among the candidates can be output.

Here, the above-described question group may include a question for asking about an outline of a certain item and a question for asking about details of the item. In this case, the question selection unit 101A preferably selects one of a plurality of questions for asking about the outline before the question for asking about the details. The question selection unit 101A may select a part of the question for asking about the details according to a classification result after the classification unit 105A classifies the subject based on an answer of the subject to the question for asking about the outline. In other words, the question selection unit 101A may determine whether to select an additional question obtained by digging these questions based on an answer to each question presented previously. As a result, it is possible to avoid giving discomfort or a burden to the subject by asking a wasteful question.

For example, the above-described question group may include a question for asking about a rough amount of assets held by the subject and a question for asking about a detailed amount of held assets. In this case, the question selection unit 101A selects a question for asking about a rough amount of held assets before the question for asking about a detailed amount of held assets. In a case where the subject is classified as a category (for example, a category in which a person who lacks knowledge and experience of investment but has confidence in investment is classified) in which it is better to check a detailed amount of held assets based on answers of the subject to a plurality of questions including the selected question, the question selection unit 101A selects a question for asking about a detailed amount of held assets. On the other hand, in a case where the subject is classified as a category in which checking of a detailed amount of held assets is unnecessary (a category in which a person with abundant knowledge and experience of investment is classified), the question selection unit 101A does not select a question for asking about a detailed amount of held assets. As a result, it is possible to minimize the opportunity to present sensitive questions of a detailed amount of held assets.

The basis information generation unit 107A generates basis information indicating a basis for recommending a portfolio to the subject based on each piece of information used to determine the portfolio to be presented to the subject. The presentation control unit 102A presents the generated basis information to the subject. According to the information processing apparatus 1A including the basis information generation unit 107A, in addition to the effect achieved by the information processing apparatus 1, it is possible to achieve an effect that the basis information, which is information useful for the subject who checks the content of the portfolio, can be presented to the subject.

A method of generating the basis information is not particularly limited. For example, the basis information generation unit 107A may evaluate a financial capacity and experience and knowledge of asset management of the subject from the answers of the subject used to generate the portfolio, and generate basis information indicating evaluation results as a basis for portfolio determination. Such basis information may also be generated by inputting the above evaluation results to a predetermined template. For example, a template such as “this portfolio is recommended for a person with a {high/average/low} financial capacity and {rich/average/poor} knowledge and experience of asset management focusing on {high return/balance between risk and return/risk avoidance}” may be used. In this case, the basis information generation unit 107A may generate the basis information by selecting one of words/phrases in a parenthesis based on an answer of the subject and inputting the selected word/phrase to the template.

The basis information generation unit 107A may also generate the basis information by using a language model or the like. In a case where the language model is used, an evaluation result for the subject may be input to the language model, or an answer of the subject used for the evaluation, the explanation of the presented portfolio, and the like may be input to the language model to cause the language model to perform the evaluation. In the latter case, the basis information generation unit 107A may generate and use a prompt for giving an instruction to explain the basis for proposing the portfolio from the input portfolio and the answer of the subject. The basis information may be in a text format, an image format (for example, a graph), or a combination of text and an image.

### (Presentation Example of Portfolio)

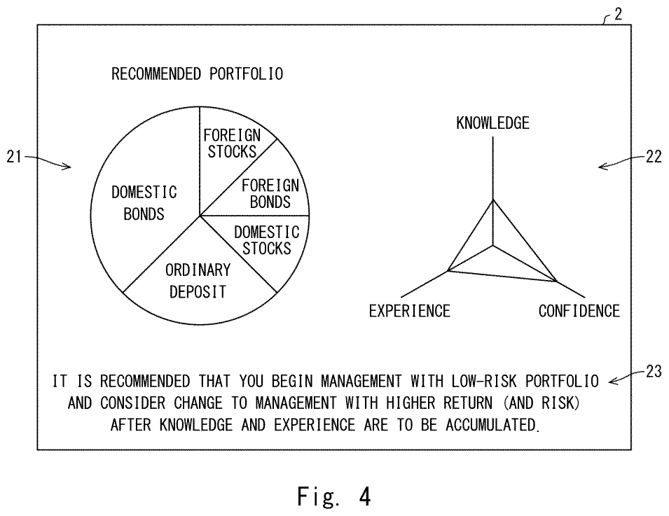

FIG. 4 is a diagram illustrating an example of a display screen for presenting a portfolio. A display screen 2 illustrated in FIG. 4 displays a circular graph 21 indicating a portfolio determined by the determination unit 106A, a radar chart 22 indicating a result of evaluating the subject on a plurality of evaluation axes, and an explanatory sentence 23 indicating a basis for recommending the portfolio. The explanatory sentence 23 is an example of basis information generated by basis information generation unit 107A.

As in the example in FIG. 4, the presentation control unit 102A may present the portfolio determined by the determination unit 106A as a graph. In particular, the portfolio is preferably presented as a circular graph as in the example in FIG. 4. The graph may be generated by the determination unit 106A or may be generated by the presentation control unit 102A. As in the example in FIG. 4, the presentation control unit 102A may present the evaluation result for the subject as a graph. The presentation control unit 102A may present, for example, a classification result for the subject by the classification unit 105A.

### (Flow of Process)

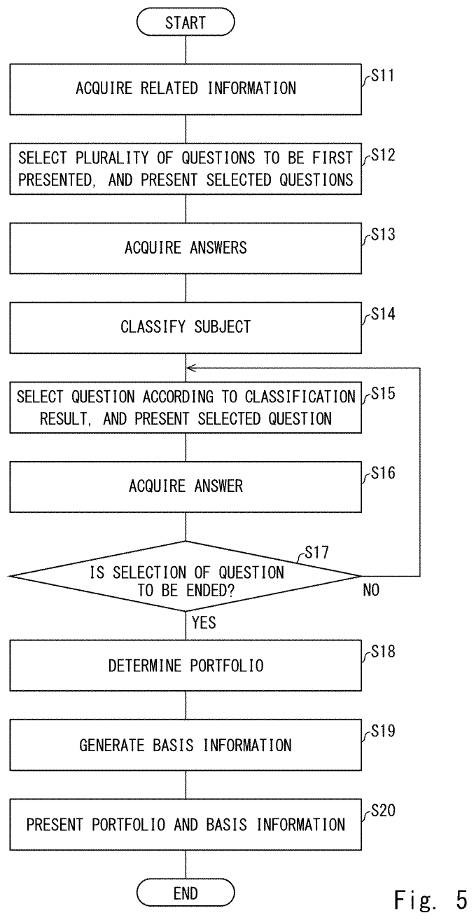

A flow of a process executed by the information processing apparatus 1A will be described with reference to FIG. 5. FIG. 5 is a flowchart illustrating an example of a process executed by the information processing apparatus 1A. FIG. 5 includes each process of the support method according to the present exemplary embodiment.

In S11, the related information acquisition unit 103A acquires related information that is information used for the question selection unit 101A to select a question for the subject. Any method of acquiring related information may be employed. For example, the related information acquisition unit 103A may acquire the related information input by the subject via the communication unit 12A or the input unit 13A, or may acquire the related information from a predetermined acquisition destination (for example, a database in which the related information of the subject is recorded in advance).

In S12, the question selection unit 101A selects a plurality of questions to be first presented to the subject from a question group for determining a portfolio of asset management. In this case, the question selection unit 101A may select a plurality of questions according to the related information acquired in S11. For example, in a case where the related information acquired in S11 indicates that the subject has rich investment experience, the question selection unit 101A may select a question for a person having rich investment experience. The presentation control unit 102A presents the question selected by the question selection unit 101A to the subject.

The plurality of questions selected in S12 are questions for classifying the subject. Therefore, in a case where the related information acquired in S11 includes information available for the classification of the subject, the information may be used for the classification of the subject. In this case, in S12, the question selection unit 101A can narrow down the number of questions to be selected. For example, in a case where the related information acquired in S11 includes information indicating at least one of age, an amount of held assets, and a segment (related to asset management), the question selection unit 101A need not select a question for asking about the information in S12. In S12, the question selection unit 101A may select a question by using a rule base in which such a rule regarding selection of a question is defined in advance.

In S13, the answer acquisition unit 104A acquires an answer of the subject to the question presented in S12. A plurality of questions may be presented at a time, or may be sequentially presented at a plurality of times. In a case where questions are presented a plurality of times, answers are also acquired a plurality of times. The same applies to S15 and S16 that will be described later.

In S14, the classification unit 105A classifies the subject based on the answer acquired in S13. For example, as described above, the classification unit 105A may classify the subject based on the result of evaluating the subject on a plurality of evaluation axes. In this classification, the classification unit 105A may use the related information acquired in S11. For example, it is assumed that the related information acquired in S11 includes data reflecting a personality of the subject such as a purchase history of a financial product, a past management record, or a document created by the subject or an e-mail transmitted by the subject. In this case, the classification unit 105A may analyze the data, and in a case where an analysis result indicating that the subject has confidence in the investment is obtained, the analysis result may be reflected in the evaluation on the evaluation axis of the confidence in the investment of the subject.

In S15 (question selection process), the question selection unit 101A selects a question to be presented to the subject next from among questions that have not been presented to the subject among the questions included in the above-described question group based on an answer of the subject to a question presented to the subject. Specifically, the question selection unit 101A selects a question associated with the classification result in S14 from the above question group. The presentation control unit 102A presents the question selected by the question selection unit 101A to the subject.

For example, if one or more questions associated with the classification are associated in advance for each classification, the question selection unit 101A can select a question associated with the classification result according to the association in S15.

In S15, the question selection unit 101A may select a question associated with the classification result by using a language model. In this case, the question selection unit 101A may input, to the language model, a prompt for giving an instruction to extract a question to be presented to the subject of the classification indicated by the classification result among the input questions, together with each question unpresented to the subject among the questions included in the question group and the classification result in S15. As a result, a question to be presented to the subject is output from the language model.

In S16, the answer acquisition unit 104A acquires an answer of the subject to the question presented in S15.

In S17, the question selection unit 101A determines whether to end the selection of a question. In a case where NO is determined in S17, the process returns to S15, and a question to be presented to the subject next is selected from among the unpresented questions. On the other hand, in a case where YES is determined in S17, the process proceeds to S18. As described above, a series of processes of selecting a question, presenting a question, and acquiring an answer is repeatedly performed until YES is determined in S17. YES being determined in S17 indicates that answers necessary for determining a portfolio to be presented to the subject are prepared.

An end conditions for the question selection in S17 may be determined in advance. For example, among the questions included in the question group described above, ending of presentation and acquisition of answers for all the questions to be presented to the subject according to the classification result in S14 may be set as an end condition for question selection. For example, acquisition of an answer necessary for the determination unit 106A to determine the portfolio may be set as an end condition for question selection. In this case, the determination unit 106A may narrow down the portfolio every time an answer is acquired in S16, and the question selection unit 101A may determine that the end condition is satisfied at the time at which the portfolio is narrowed down to one.

As described above, the question selection unit 101A may repeatedly select a question from the question group until answers necessary for determining a portfolio to be presented to the subject are prepared. As a result, in addition to the effect achieved by the information processing apparatus 1, it is possible to achieve an effect that information necessary for determining a portfolio can be collected by presenting minimum questions.

In S18, the determination unit 106A determines a portfolio to be presented to the subject based on the answer acquired in S16. The related information acquired in S11, the answer acquired in S13, the classification result in S14, and the like may also be used to determine a portfolio.

In S19, the basis information generation unit 107A generates basis information indicating a basis for recommending a portfolio to the subject based on each piece of information used to determine the portfolio in S18.

In S20 (presentation control process), the presentation control unit 102A presents a portfolio according to the answer of the subject to each of the questions selected and presented through the above processes to the subject. Specifically, the presentation control unit 102A presents the portfolio determined in S18 and the basis information generated in S19 to the subject. Accordingly, the process in FIG. 5 is ended.

The portfolio and the basis information are not necessarily presented at the same time. For example, the presentation control unit 102A may first present a portfolio and present basis information in a case where there is an input requesting presentation of the basis information from the subject. For example, the presentation control unit 102A may also present various types of information regarding the portfolio to be presented, such as the classification result in S14, to the subject.

(First Example of Process after Presentation of Portfolio)

After presenting the portfolio as described above, the information processing apparatus 1A may provide a service for receiving a question from the subject and presenting an answer to the question. However, in a case where the subject is unfamiliar with asset management, there may be a case where the subject does not know what to ask about. The prediction unit 108A and the generation control unit 109A included in the information processing apparatus 1A are for coping with such a problem.

The prediction unit 108A predicts a question item regarding asset management of the subject by using a language model subjected to machine learning of a consultation case regarding asset management. The presentation control unit 102A presents the question item predicted by the prediction unit 108A to the subject. According to the information processing apparatus 1A including the prediction unit 108A, in addition to the effect achieved by the information processing apparatus 1, it is possible to appropriately support a subject who does not know what to ask about. The machine learning of the consultation case may be performed, for example, by fine-tuning the language model by using training data in which text indicating the content of speaking of an advisee is associated with text indicating the content of an answer of an adviser to the speaking as ground truth data.

For example, the prediction unit 108A may input, to the language model, a prompt for giving an instruction to output an item to be questioned by the subject together with various types of information related to a question item that the subject wants to hear. As a result, information indicating an item that the subject should ask about is output from the language model. Examples of the various types of information include attribute information of the subject, a portfolio presented to the subject, and a classification result for the subject by the classification unit 105A. Question item candidates may be prepared in advance. In this case, the prediction unit 108A may input these candidates to the language model to determine which candidate is to be applied.

The generation control unit 109A causes the language model to generate an answer to the question. For example, it is assumed that regarding a question item predicted by the prediction unit 108A and presented to the subject, the subject inputs an answer that the subject wants to hear the question item. In this case, the generation control unit 109A inputs the above question item to the language model, and causes the language model to generate an answer to the question item. The language model used for generating an answer is preferably the same as the language model used by the prediction unit 108A, that is, a model subjected to machine learning of a consultation case regarding asset management. However, the generation control unit 109A may cause another language model such as a general-purpose language model to generate an answer. In a case where question item candidates are prepared in advance, an answer to each candidate may also be prepared in advance.

In this case, it is not necessary to cause the generation control unit 109A to generate an answer.

### (Flow of Process)

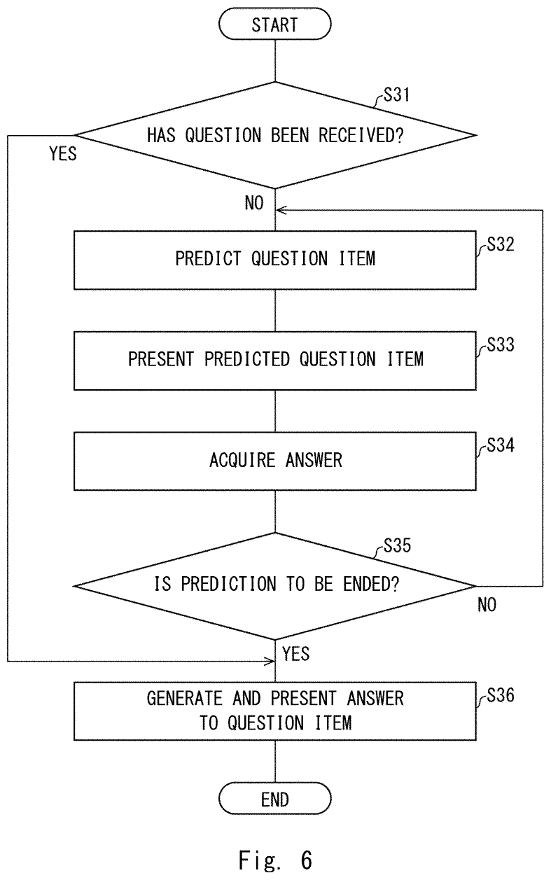

FIG. 6 is a flowchart illustrating a series of processes related to prediction of a question item. The process in FIG. 6 is performed, for example, after a portfolio is presented to the subject by the process in S20 in FIG. 5 and then acceptance of a question from the subject is started. That is, the process in FIG. 6 may be performed subsequent to the series of processes in FIG. 5.

In S31, the generation control unit 109A determines whether a question from the subject has been received. In a case where YES is determined in S31, the process proceeds to S36, and in a case where NO is determined in S31, the process proceeds to S32. For example, the generation control unit 109A may determine that a question has not been received (NO in S31) in a case where no question has been input even after a predetermined time has elapsed from the start of reception of a question.

In S32, the prediction unit 108A predicts a question item regarding asset management of the subject by using a language model subjected to machine learning of a consultation case regarding asset management. Before a question item is predicted, a dialogue using a language model may be performed with the subject. In that case, the prediction unit 108A may also input the content of the dialogue with the subject to the language model and reflect the content of the dialogue in a prediction result.

In S33, the presentation control unit 102A presents the question item predicted in S32 to the subject. Subsequently, in S34, the answer acquisition unit 104A acquires an answer of the subject to the presented question item. For example, together with the question item predicted in S32, the presentation control unit 102A may display an option for selecting whether the question item includes content that the subject wants to hear. In this case, in S34, a selection result of the subject for the displayed option may be acquired as the answer of the subject.

In S35, the answer acquisition unit 104A determines whether to end the prediction of the prediction unit 108A based on the answer acquired in S34. An end condition for the prediction may be determined in advance. For example, it may be set as the end condition that there has been an input of the subject indicating that the subject wants to hear an answer to the presented question item. For example, the answer acquisition unit 104A may determine to end the prediction in a case where the input of the subject indicating that the subject wants to hear an answer cannot be obtained even if the prediction and presentation of the question item are repeated a predetermined number of times.

In S36 proceeding from S35, the generation control unit 109A generates an answer to the question item presented in S33 (the input indicating that the subject wants to hear an answer). As described above, the generation control unit 109A can generate an answer to the question item by inputting the question item to the language model. The generated answer is presented to the subject by the presentation control unit 102A, and thus the process in FIG. 6 is ended. After S36, a question of the subject to the presented answer may be accepted.

On the other hand, in S36 proceeding from S31, the generation control unit 109A generates an answer to the question input by the subject. Also in this case, the generation control unit 109A can generate an answer to the question by inputting the question input by the subject to the language model. The generated answer is presented to the subject by the presentation control unit 102A.

(Second Example of Process after Presentation of Portfolio)

After presenting the portfolio, the information processing apparatus 1A may provide a service for supporting determination of an investment destination. Such a service can be enabled by the generation control unit 109A included in the information processing apparatus 1A.

As described above, the generation control unit 109A causes the language model to generate an answer to the question. The generation control unit 109A may also cause the language model to generate a question for the subject. For example, the generation control unit 109A may input, to the language model, a prompt for giving an instruction to generate a question for eliciting information necessary for determining an investment destination together with various types of information serving as a reference for generating an accurate question. As a result, a question for eliciting information necessary for determining an investment destination is output from the language model. As the various types of information, at least attribute information of the subject and a portfolio presented to the subject are used. The various types of information may include, for example, a classification result for the subject by the classification unit 105A, attribute information of the subject, and a history of a dialogue between the subject and the information processing apparatus 1A.

As described above, the information processing apparatus 1A includes the generation control unit 109A that causes a language model subjected to machine learning to generate a question for eliciting information necessary for determining an investment destination according to a presented portfolio from a subject. Therefore, according to the information processing apparatus 1A, in addition to the effect achieved by the information processing apparatus 1, it is possible to achieve an effect of eliciting, from a subject, information necessary for determining an investment destination according to a portfolio without through an operator.

For example, in order to determine the portfolio, a specific amount of funds to be invested by the subject or the like is not necessarily required. On the other hand, at the stage of determining an investment destination, it is necessary to ascertain a specific amount of funds to be invested. Therefore, the generation control unit 109A may cause the language model to generate a question for eliciting a specific amount of funds to be invested. In this manner, by prescribing information necessary for determining an investment destination in advance, the generation control unit 109A can generate a question for eliciting such information.

In a case where a financial product to be a candidate for an investment destination is determined in advance, the generation control unit 109A may input each financial product and an explanatory sentence thereof to the language model to generate a question for eliciting information necessary for determining which financial product should be selected. In this case, by acquiring an answer of the subject to each generated question, one or a plurality of financial products to be selected by the subject can be specified.

Here, if the subject is a person in a country or a region where recommending a financial product through a computer is not regulated by laws and regulations, the presentation control unit 102A may present the specified financial product to the subject as a recommended financial product. On the other hand, if the subject is a person in a country or a region where recommending a financial product through a computer is regulated by laws and regulations, the presentation control unit 102A may notify an operator who can recommend a financial product of the specified financial product. As a result, the operator can support the subject to purchase the financial product with reference to the specified financial product.

In a case of generating a question, the generation control unit 109A may also generate a question in consideration of attribute information of the subject and preference information indicating the preference of the subject by inputting the attribute information and the preference information to the language model. For example, it is also possible to generate a question for directly asking about an amount of money for a subject who likes direct expression, and a question for indirectly asking about an amount of money for a subject who does not like direct expression.

It is also effective to change a language model to be used according to the attribute information and preference information of the subject. In this case, for each classification of the subject (which may be classification by the classification unit 105A or classification based on other criteria), a language model fine-tuned in such a way as to conform to a dialogue with the person of the classification may be used. As a result, it is possible to perform a dialogue with the subject in a tone, a development of speech, or a tone according to the classification of the subject. According to the classification of the subject, it is also possible to generate an optimal question or answer from a behavioral economic viewpoint, in other words, an effective question or answer for prompting the subject to perform a predetermined behavior.

### (Flow of Process)

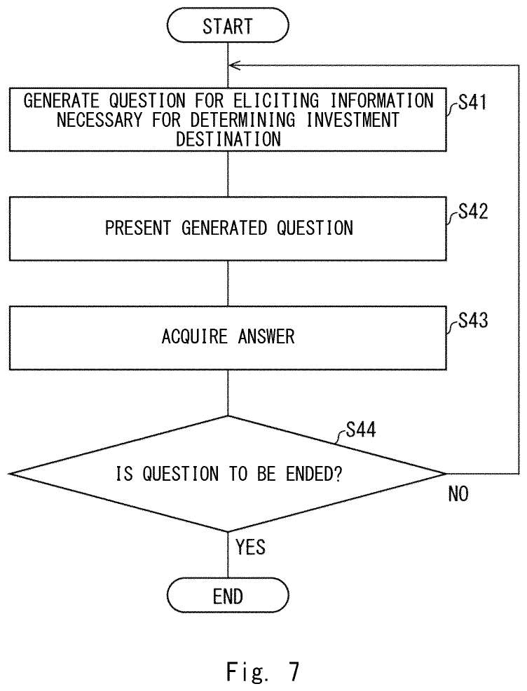

FIG. 7 is a flowchart illustrating a series of processes of investment destination determination support. The process in FIG. 7 is performed, for example, after the portfolio is presented to the subject. That is, the process in FIG. 7 may be performed subsequent to the series of processes in FIG. 5.

In S41, the generation control unit 109A causes the language model subjected to machine learning to generate a question for eliciting, from the subject, information necessary for determining an investment destination according to the portfolio presented to the subject.

In S42, the presentation control unit 102A presents the question generated in S41 to the subject. In S43, the answer acquisition unit 104A acquires an answer of the subject to the question presented in S42.

In S44, the presentation control unit 102A determines whether to end generation of a question. In a case where YES is determined in S44, the process in FIG. 7 is ended. On the other hand, in a case where NO is determined in S44, the process returns to S41. In S41 proceeding from S44, the generation control unit 109A may also input a history of the dialogue up to the previous time to the language model. As a result, it is possible to generate a new question in consideration of the history of the dialogue up to the previous time.

A condition for ending the generation of the question in S44 may be determined in advance. For example, speaking from the subject to end the dialogue or an operation to end the dialogue by the subject may be set as the end condition. For example, completion of collecting all information necessary for determining an investment destination may be set as the end condition. Whether the information necessary for determining the investment destination has been collected can be determined, for example, by listing information necessary for determining an investment destination in advance and comparing the list with the answer acquired in S43. A language model may also be used for this determination.

By executing the processes as illustrated in FIGS. 6 and 7, it is possible to obtain additional information regarding the subject such as a dialogue history with the subject. Thus, in a case where a dialogue with the subject is performed after once determining the portfolio, the determination unit 106A may change the proposed portfolio based on the content of the dialogue. The presentation control unit 102A presents the changed portfolio to the subject. As a result, it is possible to repropose a portfolio more suitable for the subject.

### [Modified Examples]

An executing entity of each process described in the above-described exemplary embodiment is optional, and is not limited to the above-described example. For example, a system having functions similar to those of the information processing apparatuses 1 and 1A can be constructed by a plurality of apparatuses capable of communicating with each other. The executing entity of each process illustrated in the flowcharts of FIGS. 5 to 7 may be one apparatus (also referred to as a processor) or a plurality of apparatuses (also referred to as processors).

### [Example of Implementation Using Software]

Some or all of the functions of the information processing apparatuses 1 and 1A may be achieved by hardware such as an integrated circuit (IC chip) or may be achieved by software.

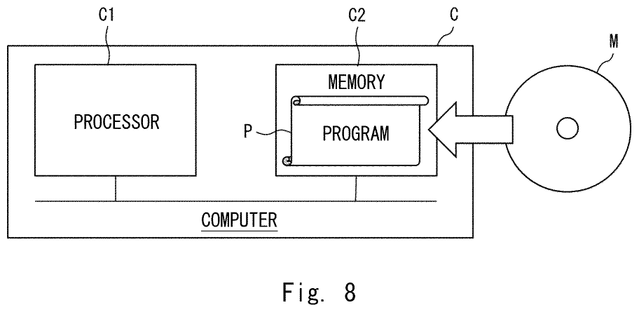

In the latter case, the information processing apparatuses 1 and 1A are implemented, for example, by a computer that executes a command of a program that is software for achieving each function. An example of such a computer (hereinafter, referred to as a computer C) is illustrated in FIG. 8. FIG. 8 is a block diagram illustrating a hardware configuration of the computer C that functions as the information processing apparatus 1 or 1A.

The computer C includes at least one processor C1 and at least one memory C2. In the memory C2, a program P for causing the computer C to operate as the information processing apparatus 1 or 1A is recorded. In the computer C, the processor C1 reads the program P from the memory C2 and executes the program P, thereby achieving the functions of the information processing apparatus 1 or 1A.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof may be used. As the memory C2, for example, a flash memory, a hard disk drive (HDD), a solid state drive (SSD), or a combination thereof may be used.

The computer C may further include a random access memory (RAM) for loading the program P at the time of execution and temporarily storing various types of data. The computer C may further include a communication interface for transmitting and receiving data to and from other apparatuses. The computer C may further include an input/output interface for connecting input/output devices such as a keyboard, a mouse, a display, and a printer.

The program P may be recorded in a non-transitory tangible recording medium M readable by the computer C. As such a recording medium M, for example, a tape, a disk, a card, a semiconductor memory, a programmable logic circuit, or the like may be used. The computer C can acquire the program P via such a recording medium M. The program P may be transmitted via a transmission medium. As such a transmission medium, for example, a communication network, a broadcast wave, or the like may be used. The computer C can also acquire the program P via such a transmission medium.

Each of the above-described functions of the information processing apparatus 1 or 1A may be achieved by a single processor provided in a single computer, may be achieved by a plurality of processors provided in a single computer in cooperation, or may be achieved by a plurality of processors respectively provided in a plurality of computers in cooperation. The program for causing the information processing apparatuses 1 and 1A to achieve each of the above-described functions may be stored in a single memory provided in a single computer, may be stored in a distributed manner in a plurality of memories provided in a single computer, or may be stored in a distributed manner in a plurality of memories respectively provided in a plurality of computers.

### [Supplementary Notes]

The whole or part of the example embodiments disclosed above can be described as, but not limited to, the following supplementary notes.

### (Supplementary Note A1)

An information processing apparatus including: question selection means for selecting a question to be presented to a subject next from among unpresented questions among questions included in a question group based on an answer of the subject to a question selected from the question group for determining a portfolio of asset management and presented to the subject; and presentation control means for presenting, to the subject, a portfolio according to an answer of the subject to each of the selected and presented questions.

### (Supplementary Note A2)

The information processing apparatus according to Supplementary Note A1, in which the question selection means selects a plurality of from the question group, the information processing apparatus further includes classification means for classifying the subject based on answers to the plurality of questions, in which the question selection means selects a question according to the classification of the subject as a question to be presented next after the plurality of questions.

### (Supplementary Note A3)

The information processing apparatus according to Supplementary Note A2, in which the classification means evaluates the subject on a plurality of predetermined evaluation axes including at least one of knowledge of investment, experience of investment, confidence in investment, calm, and behavioral propensities, and classifies the subject based on a result of the evaluation.

### (Supplementary Note A4)

The information processing apparatus according to Supplementary Note A2 or A3, in which the classification means classifies the subject based on an evaluation result obtained by relatively evaluating the subject with another person.

### (Supplementary Note A5)

The information processing apparatus according to any one of Supplementary Notes A1 to A4, in which the question selection means repeatedly selects a question from the question group until answers necessary for determining a portfolio to be presented to the subject are prepared.

### (Supplementary Note A6)

The information processing apparatus according to any one of Supplementary Notes A1 to A5, further including basis information generation means for generating basis information indicating a basis for recommending a portfolio to the subject based on each piece of information used to determine the portfolio to be presented to the subject, in which the presentation control means presents the basis information to the subject.

### (Supplementary Note A7)

The information processing apparatus according to any one of Supplementary Notes A1 to A6, further including prediction means for predicting a question item regarding asset management of the subject by using a language model subjected to machine learning of a consultation case regarding asset management, in which the presentation control means presents the predicted question item to the subject.

### (Supplementary Note A8)

The information processing apparatus according to any one of Supplementary Notes A1 to A7, further including generation control means for causing a language model subjected to machine learning to generate a question for eliciting, from the subject, information necessary for determining an investment destination according to the presented portfolio.

### (Supplementary Note B1)

A support method including: a question selection process in which at least one processor selects a question to be presented to a subject next from among unpresented questions among questions included in a question group based on an answer of the subject to a question selected from the question group for determining a portfolio of asset management and presented to the subject; and a presentation control process in which the at least one processor presents, to the subject, a portfolio according to an answer of the subject to each of the selected and presented questions.

### (Supplementary Note B2)

The support method according to Supplementary Note B1, in which the at least one processor selects a plurality of questions from the question group, the support method further includes a classification process in which the at least one processor classifies the subject based on answers to the plurality of questions, and, in the question selection process, the at least one processor selects a question according to the classification of the subject as a question to be presented next after the plurality of questions.

### (Supplementary Note B3)

The support method according to Supplementary Note B2, in which, in the classification process, the at least one processor evaluates the subject on a plurality of predetermined evaluation axes including at least one of knowledge of investment, experience of investment, confidence in investment, calm, and behavioral propensities, and classifies the subject based on a result of the evaluation.

### (Supplementary Note B4)

The support method according to Supplementary Note B2 or B3, in which, in the classification process, the at least one processor classifies the subject based on an evaluation result obtained by relatively evaluating the subject with another person.

### (Supplementary Note B5)

The support method according to any one of Supplementary Notes B1 to B4, in which, in the question selection process, the at least one processor repeatedly selects a question from the question group until answers necessary for determining a portfolio to be presented to the subject are prepared.

### (Supplementary Note B6)

The support method according to any one of Supplementary Notes B1 to B5, further including: a basis information generation process in which the at least one processor generates basis information indicating a basis for recommending a portfolio to the subject based on each piece of information used to determine the portfolio to be presented to the subject; and a process in which the at least one processor presents the basis information to the subject.

### (Supplementary Note B7)

The support method according to any one of Supplementary Notes B1 to B6, further including: a prediction process in which the at least one processor predicts a question item regarding asset management of the subject by using a language model subjected to machine learning of a consultation case regarding asset management; and a process in which the at least one processor presents the predicted question item to the subject.

### (Supplementary Note B8)

The support method according to any one of Supplementary Note B1 to B7, further including a generation control process in which the at least one processor causes a language model subjected to machine learning to generate a question for eliciting, from the subject, information necessary for determining an investment destination according to the presented portfolio.

### (Supplementary Note C1)

A non-transitory computer readable medium storing a support program for causing a computer to function as: question selection means for selecting a question to be presented to a subject next from among unpresented questions among questions included in a question group based on an answer of the subject to a question selected from the question group for determining a portfolio of asset management and presented to the subject; and presentation control means for presenting, to the subject, a portfolio according to an answer of the subject to each of the selected and presented questions.

### (Supplementary Note C2)

The non-transitory computer readable medium storing the support program according to Supplementary Note C1, in which the question selection means selects a plurality of questions from the question group, the support program causes the computer to further function as classification means for classifying the subject based on answers to the plurality of questions, and the question selection means selects a question according to the classification of the subject as a question to be presented next after the plurality of questions.

### (Supplementary Note C3)

The non-transitory computer readable medium storing the support program according to Supplementary Note C2, in which the classification means evaluates the subject on a plurality of predetermined evaluation axes including at least one of knowledge of investment, experience of investment, confidence in investment, calm, and behavioral propensities, and classifies the subject based on a result of the evaluation.

### (Supplementary Note C4)

The non-transitory computer readable medium storing the support program according to Supplementary Note C2 or C3, in which the classification means classifies the subject based on an evaluation result obtained by relatively evaluating the subject with another person.

### (Supplementary Note C5)

The non-transitory computer readable medium storing the support program according to any one of Supplementary Notes C1 to C4, in which the question selection means repeatedly selects a question from the question group until answers necessary for determining a portfolio to be presented to the subject are prepared.

### (Supplementary Note C6)

The non-transitory computer readable medium storing the support program according to any one of Supplementary Notes C1 to C5, in which the support program causes the computer to further function as basis information generation means for generating basis information indicating a basis for recommending a portfolio to the subject based on each piece of information used to determine the portfolio to be presented to the subject, and the presentation control means presents the basis information to the subject.

### (Supplementary Note C7)

The non-transitory computer readable medium storing the support program according to any one of Supplementary Notes C1 to C6, in which the support program causes the computer to further function as prediction means for predicting a question item regarding asset management of the subject by using a language model subjected to machine learning of a consultation case regarding asset management, and the presentation control means presents the predicted question item to the subject.

### (Supplementary Note C8)

The non-transitory computer readable medium storing the support program according to any one of Supplementary Notes C1 to C7, in which the support program causes the computer to further function as generation control means for causing a language model subjected to machine learning to generate a question for eliciting, from the subject, information necessary for determining an investment destination according to the presented portfolio.

### (Supplementary Note D1)

An information processing apparatus including at least one processor, in which the at least one processor executes: a question selection process of selecting a question to be presented to a subject next from among unpresented questions among questions included in a question group based on an answer of the subject to a question selected from the question group for determining a portfolio of asset management and presented to the subject; and a presentation control process of presenting, to the subject, a portfolio according to an answer of the subject to each of the selected and presented questions.

The information processing apparatus may further include a memory. The memory may store a program for causing the at least one processor to execute the process.

### (Supplementary Note D2)

The information processing apparatus according to Supplementary Note D1, in which, in the question selection process, the at least one processor selects a plurality of questions from the question group, the at least one processor further executes a classification process of classifying the subject based on answers to the plurality of questions, and, in the question selection process, the at least one processor selects a question according to the classification of the subject as a question to be presented next after the plurality of questions.

### (Supplementary Note D3)

The information processing apparatus according to Supplementary Note D2, in which, in the classification process, the at least one processor evaluates the subject on a plurality of predetermined evaluation axes including at least one of knowledge of investment, experience of investment, confidence in investment, calm, and behavioral propensities, and classifies the subject based on a result of the evaluation.

### (Supplementary Note D4)

The information processing apparatus according to Supplementary Note D2 or D3, in which, in the classification process, the at least one processor classifies the subject based on an evaluation result obtained by relatively evaluating the subject with another person.

### (Supplementary Note D5)

The information processing apparatus according to any one of Supplementary Notes D1 to D4, in which, in the question selection process, the at least one processor repeatedly selects a question from the question group until answers necessary for determining a portfolio to be presented to the subject are prepared.

### (Supplementary Note D6)

The information processing apparatus according to any one of Supplementary Notes D1 to D5, in which the at least one processor further executes a basis information generation process of generating basis information indicating a basis for recommending a portfolio to the subject based on each piece of information used to determine the portfolio to be presented to the subject, and a process of presenting the basis information to the subject.

### (Supplementary Note D7)

The information processing apparatus according to any one of Supplementary Notes D1 to D6, in which the at least one processor further executes a prediction process of predicting a question item regarding asset management of the subject by using a language model subjected to machine learning of a consultation case regarding asset management; and a process of presenting the predicted question item to the subject.

### (Supplementary Note D8)

The information processing apparatus according to any one of Supplementary Notes D1 to D7, in which the at least one processor executes a generation control process of causing a language model subjected to machine learning to generate a question for eliciting, from the subject, information necessary for determining an investment destination according to the presented portfolio.

### (Supplementary Note E)

A non-transitory recording medium recording a support program for causing a computer to execute: a question selection process of selecting a question to be presented to a subject next from among unpresented questions among questions included in a question group based on an answer of the subject to a question selected from the question group for determining a portfolio of asset management and presented to the subject; and a presentation control process of presenting, to the subject, a portfolio according to an answer of the subject to each of the selected and presented questions.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments. Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. An information processing apparatus comprising:
at least one memory storing instructions; and
at least one processor configured to execute the instructions to:
select a question to be presented to a subject next from among unpresented questions among questions included in a question group based on an answer of the subject to a question selected from the question group for determining a portfolio of asset management and presented to the subject; and
present, to the subject, a portfolio according to an answer of the subject to each of the selected and presented questions.

2. The information processing apparatus according to claim 1, wherein the processor is further configured to execute the instructions to:
select a plurality of questions from the question group,
classify the subject based on answers to the plurality of questions, and
select a question according to the classification of the subject as a question to be presented next after the plurality of questions.

3. The information processing apparatus according to claim 2, wherein the processor is further configured to execute the instructions to evaluate the subject on a plurality of predetermined evaluation axes including at least one of knowledge of investment, experience of investment, confidence in investment, calm, and behavioral propensities, and classify the subject based on a result of the evaluation.

4. The information processing apparatus according to claim 2, wherein the processor is further configured to execute the instructions to classify the subject based on an evaluation result obtained by relatively evaluating the subject with another person.

5. The information processing apparatus according to claim 1, wherein the processor is further configured to execute the instructions to repeatedly select a question from the question group until answers necessary for determining a portfolio to be presented to the subject are prepared.

6. The information processing apparatus according to claim 1, the processor is further configured to execute the instructions to:
generate basis information indicating a basis for recommending a portfolio to the subject based on each piece of information used to determine the portfolio to be presented to the subject, and
present the basis information to the subject.

7. The information processing apparatus according to claim 1, the processor is further configured to execute the instructions to:
predict a question item regarding asset management of the subject by using a language model subjected to machine learning of a consultation case regarding asset management, and
present the predicted question item to the subject.

8. The information processing apparatus according to claim 1, the processor is further configured to execute the instructions to cause a language model subjected to machine learning to generate a question for eliciting, from the subject, information necessary for determining an investment destination according to the presented portfolio.

9. A support method comprising:
a question selection process in which at least one processor selects a question to be presented to a subject next from among unpresented questions among questions included in a question group based on an answer of the subject to a question selected from the question group for determining a portfolio of asset management and presented to the subject; and
a presentation control process in which the at least one processor presents, to the subject, a portfolio according to an answer of the subject to each of the selected and presented questions.

10. The support method according to claim 9, wherein
the at least one processor selects a plurality of questions from the question group,
the support method further comprises a classification process in which the at least one processor classifies the subject based on answers to the plurality of questions, and
in the question selection process, the at least one processor selects a question according to the classification of the subject as a question to be presented next after the plurality of questions.

11. The support method according to claim 10, wherein, in the classification process, the at least one processor evaluates the subject on a plurality of predetermined evaluation axes including at least one of knowledge of investment, experience of investment, confidence in investment, calm, and behavioral propensities, and classifies the subject based on a result of the evaluation.

12. The support method according to claim 10, wherein, in the classification process, the at least one processor classifies the subject based on an evaluation result obtained by relatively evaluating the subject with another person.

13. The support method according to claim 9, wherein, in the question selection process, the at least one processor repeatedly selects a question from the question group until answers necessary for determining a portfolio to be presented to the subject are prepared.

14. The support method according to claim 9, further comprising:
a basis information generation process in which the at least one processor generates basis information indicating a basis for recommending a portfolio to the subject based on each piece of information used to determine the portfolio to be presented to the subject; and
a process in which the at least one processor presents the basis information to the subject.

15. The support method according to claim 9, further comprising:
a prediction process in which the at least one processor predicts a question item regarding asset management of the subject by using a language model subjected to machine learning of a consultation case regarding asset management; and
a process in which the at least one processor presents the predicted question item to the subject.

16. The support method according to claim 9, further comprising a generation control process in which the at least one processor causes a language model subjected to machine learning to generate a question for eliciting, from the subject, information necessary for determining an investment destination according to the presented portfolio.

17. A non-transitory computer readable medium storing a support program for causing a computer to execute:
a question selection process of selecting a question to be presented to a subject next from among unpresented questions among questions included in a question group based on an answer of the subject to a question selected from the question group for determining a portfolio of asset management and presented to the subject; and
a presentation control process of presenting, to the subject, a portfolio according to an answer of the subject to each of the selected and presented questions.

18. The non-transitory computer readable medium storing the support program according to claim 17, wherein
in the question selection process, a plurality of questions are selected from the question group,
the support program causes the computer to further execute a classification process of classifying the subject based on answers to the plurality of questions, and
in the question selection process, a question according to the classification of the subject is selected as a question to be presented next after the plurality of questions.

19. The non-transitory computer readable medium storing the support program according to claim 18, wherein, in the classification process, the subject is evaluated on a plurality of predetermined evaluation axes including at least one of knowledge of investment, experience of investment, confidence in investment, calm, and behavioral propensities, and the subject is classified based on a result of the evaluation.

20. The non-transitory computer readable medium storing the support program according to claim 18, wherein, in the classification process, the subject is classified based on an evaluation result obtained by relatively evaluating the subject with another person.
